(19) United States
(12) Patent Application Publication
(10) Pub. No.: US 2012/0221483 A1
(43) Pub. Date: Aug. 30, 2012

(54) SINGLE-POT MARGINING WITH DIFFERING LIQUIDATION PERIODS

(76) Inventors: Qunfeng Yang, New York, NY (US); Heng Sun, Oakland Gardens, NY (US)

(21) Appl. No.: 13/407,368

(22) Filed: Feb. 28, 2012

Related U.S. Application Data
(60) Provisional application No. 61/447,429, filed on Feb. 28, 2011.

(51) Int. Cl. G06Q 40/06

(52) U.S. Cl. 705/36 R

(57) ABSTRACT

A computer-implemented method for determining a margin for a clearinghouse member position including both securities and derivatives. One example method includes receiving data at a margin calculation computer server on a securities position maintained by a clearing member and a derivatives position maintained by the clearing member. The method may further include calculating using the margin calculation computer server a single margin requirement for the member for both the securities position and the derivatives position using a first liquidation period for the securities position and a second different liquidation period for the derivatives position in the calculation of the margin requirement.

### CROSS-REFERENCE TO RELATED APPLICATION

This application claims the benefit of U.S. Provisional Patent application Ser. No. 61/447,429, filed Feb. 28, 2011, which is incorporated herein by reference.

### BACKGROUND

A clearinghouse may be a financial institution or organization responsible for clearing trades on an exchange or trades captured through other mechanisms, such as firm-to-firm trades and inter-dealer broker trades. When members of an exchange, clearing members, or customers or clients of clearing members, wish to make a trade on the exchange, the clearinghouse may assume the counterparty risk for both sides of the trade through the process of novation. In a trade where Party A sells to Party B, the clearinghouse may act as the seller to Party B and the buyer from Party A.

One of the primary purposes of the clearinghouse, in clearing trades between clearing members, is to reduce the risk to both parties to a trade. The clearinghouse may do this through, for example, netting transactions, independently valuing trades and collateral, credit monitoring clearing members, providing a guaranty fund funded by clearing members, and requiring margin deposits be made by clearing members. Risk types on a trade may include price risk, market risk, settlement risk, systemic risk, default risk, pre-settlement risk, liquidity risk, replacement risk, and so on.

Margin may be money or securities or other negotiable interests or guarantees that clearing members deposit with their clearinghouses each day to make sure the clearing member or its customers have enough collateral or back-up funds available to cover any financial exposure on trades that are settling on that day. Margin deposits may be held by a clearinghouse, for example, in a clearing fund. Futures clearinghouses may use a guaranty fund in addition to holding margin deposits. The margin deposit required for a clearing member may be calculated based on the risk to the clearinghouse of the clearing member's portfolio in the event of the member's default. A major part of the margin requirement may be original margin. The calculation of the original margin requirement may use any known methodology for evaluating risk in a portfolio, including, for example, Value-at-Risk methodology and the SPAN™ system. Once the original margin requirement has been determined, the clearing member may deposit collateral with the clearinghouse to satisfy the original margin requirement. Further margin calculations may be performed on a clearing member's portfolio during a trading day, based on changes made in the clearing member's portfolio and/or changes in the market environment. This may result in the requirement of additional margin deposits on an intraday basis. In addition, a clearing member's unsettled portfolio may be subject to mark-to-market, the portfolio value change resulting from the difference between the clearing member's trade price and the clearinghouse's independently determined market price, and the clearinghouse may charge the mark-to-market loss through variation margin to bring the portfolio value current from the trade time. A clearinghouse's request to a clearing member to transmit funds or securities to cover a margin requirement may be referred to as a margin call. The clearinghouse may accept cash or securities as collateral to cover an original margin requirement, but may only accept cash to cover a variation margin requirement. Cash used to cover variation margin may be passed among clearing members from those with mark-to-market loss to those with mark-to-market profit, rather than held by the clearinghouse.

Previously, margin requirements for separate portfolios maintained by separate clearinghouses by the same clearing member were calculated separately. An organization which was a clearing member of a futures clearinghouse and a securities clearinghouse would have a separate portfolio at each clearinghouse, and separate margin requirements for each portfolio. This resulted in margin requirements that were excessive relative to the risk of the positions in the member's portfolio, because they failed to take into account instances where holdings in one clearinghouse offset the risk of holdings in the other clearinghouse.

Single-pot margining may allow for the calculation of a single margin requirement for a securities portfolio and a derivatives portfolio, allowing the two portfolios to be treated as one single-pot portfolio for margin purposes. Portfolios with other types of financial instruments may also be included in the single pot portfolio. This may result in lower margin requirements for a clearing member, providing capital efficiencies by allowing the clearing member to keep more money on hand instead of depositing it with the clearinghouse, while still providing the clearinghouse enough capital to cover the risks in the clearing member's portfolio. Single-pot margining may use similar calculations to the margin calculations for separate portfolios, and may assume the same liquidation period for derivatives and securities.

### BRIEF DESCRIPTION OF THE DRAWINGS

FIG. 1 is a functional block diagram of an exemplary system for single-pot margining with differing liquidation periods, according to one exemplary embodiment of the present invention;

FIG. 2 is a flow chart showing an exemplary procedure or method for single-pot margining with differing liquidation periods, according to one exemplary embodiment of the present invention;

FIG. 3 is an exemplary timeline for single-pot margining with differing liquidation periods, according to one exemplary embodiment of the present invention;

FIG. 4 is a functional block diagram of an exemplary system for single-pot margining with differing liquidation periods and margin deposits split between settling banks, according to one exemplary embodiment of the present invention;

FIG. 5 is a functional block diagram of an exemplary system architecture for single-pot margining with differing liquidation periods;

FIG. 6 is a functional block diagram of an exemplary margin calculation computer server for single-pot margining with differing liquidation periods;

FIG. 7 is a functional block diagram of an exemplary clearing fund management system for single-pot margining with differing liquidation periods;

FIG. 8 is a functional block diagram of an exemplary member computer system for single-pot margining with differing liquidation periods;

FIG. 9 is a functional block diagram of an exemplary member settling bank server for single-pot margining with differing liquidation periods;

FIG. 10 is a functional block diagram of an exemplary clearinghouse settling bank server for single-pot margining with differing liquidation periods;

FIG. 11 is a functional block diagram of an exemplary client trading systems server for single-pot margining with differing liquidation periods;

FIG. 12 is a functional block diagram of an exemplary exchange computer server for single-pot margining with differing liquidation periods; and

FIG. 13 is a functional block diagram of an exemplary clearinghouse computer server for single-pot margining with differing liquidation periods;

FIG. 14 is an exemplary inter-system flow chart for single-pot margining with differing liquidation periods;

FIG. 15 is an exemplary inter-system flow chart for single-pot margining with differing liquidation periods; and

FIG. 16 is an exemplary inter-system flow chart for single-pot margining with differing liquidation periods.

### DESCRIPTION

Single-pot margining, as currently used, may assume the same liquidation period for both derivatives and securities. In practice, however, derivatives and securities may have differing liquidation periods. For example, securities may take longer to liquidate than derivatives. Margin requirements calculated using single-pot margining assuming the same liquidation period for all of the holdings in the single-pot portfolio, such as derivatives and securities, may inaccurately measure the risk associated with the portfolio and result in a margin requirement that is too high or too low.

Single-pot margining may be modified to incorporate differing liquidation periods for the different holdings in the single-pot portfolio. The single-pot margin calculation may be performed using, for example, a one day liquidation period for derivatives, which are often highly liquid, and a three day liquidation period for securities, which may be less liquid than derivatives.

Some example embodiments include methods that can be configured and executed to perform single-pot margining with differing liquidation periods. One exemplary embodiment may provide a computer-implemented method of determining a margin for a clearinghouse member position including both securities and derivatives, including receiving data at a margin calculation computer server on at least one securities position maintained by a clearing member and on at least one derivatives position maintained by the clearing member. The method may further include calculating using the margin calculation computer server a single margin requirement for the clearing member for both the at least one securities position and the at least one derivatives position using a first liquidation period for the at least one securities position and a second different liquidation period for the at least one derivatives position in the calculation of the margin requirement.

Another exemplary embodiment may provide a computer-implemented method of determining a margin for a clearinghouse member position including both securities and derivatives, including sending data to a margin calculation computer server on at least one securities position maintained by a clearing member and at least one derivatives position maintained by the clearing member. The method may further include receiving from the margin calculation computer server a single margin requirement for the clearing member for both the at least one securities position and the at least one derivatives position using a first liquidation period for the at least one securities position and a second different liquidation period for the at least one derivatives position in the calculation of the margin requirement.

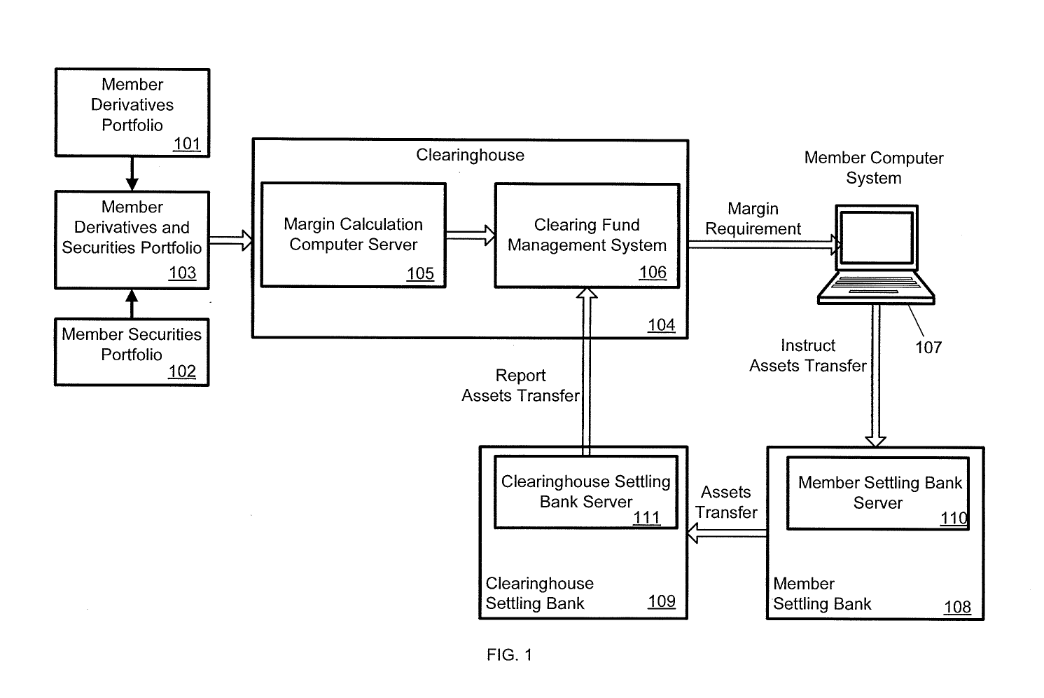

FIG. 1 depicts an exemplary system for single-pot margining with differing liquidation periods. The exemplary system may include a member derivatives portfolio 101, a member securities portfolio 102, a member derivatives and securities portfolio 103, a clearinghouse 104, a margin calculation computer server 105, a clearing fund management system 106, a member computer system 107, a member settling bank 108, and a clearinghouse settling bank 109.

The member derivatives portfolio 101 may be a portfolio of derivatives position maintained by a clearing member of a derivatives clearinghouse. The member derivatives portfolio 101 may include any suitable derivatives of any suitable underlying assets, such as, for example, options, futures, warrants, forwards and swaps on interest rates, foreign currency, credit, equity, and commodities. The member derivatives portfolio 101 may be maintained at any suitable derivatives clearinghouse, which may be associated with a derivatives exchange. For example, the derivatives exchange on which the member derivatives portfolio 101 is transacted may be the NYSE Liffe U.S., which may clear through New York Portfolio Clearing. Data about the member derivatives portfolio 101 may be stored in any suitable location, for example, at servers at the derivatives clearinghouse.

The member securities portfolio 102 may be a portfolio of securities position maintained at a securities clearinghouse by the same clearing member who maintains the member derivatives portfolio 101, or by a company affiliated with the clearing member. The member securities portfolio 102 may include any suitable securities, including, for example, fixed income securities, bonds, stocks, asset-backed securities, exchange traded funds, and credit-linked notes. The member securities portfolio 102 may be maintained at any suitable securities clearinghouse which may clear trades through any suitable trade capture mechanism, including trades through securities exchange, over the counter marketplace, firm-to-firm trades, and inter-dealer broker trades. For example, trades captured for the member securities portfolio 102 from an inter-dealer broker may clear through the Fixed Income Clearing Corporation. As another example, the securities portfolio 102 may be transacted through an over the counter marketplace. Data about the member derivatives portfolio 101 may be stored in any suitable location, for example, at servers at the securities clearinghouse.

The member derivatives and securities portfolio 103, or single-pot portfolio, may be a combination of the derivatives maintained in the member derivatives portfolio 101 and the securities maintained in the member securities portfolio 102. The member derivatives and securities portfolio 103 may be a portfolio that is constructed through the combination of data about the member derivatives portfolio 101 and the member securities portfolio 102 only when needed to perform single-pot margining. For example, if the member derivatives and securities portfolio 103 is constructed only when needed, the member derivatives portfolio 101 and the member securities portfolio 102 may be separate portfolios, accessed by their respective clearinghouses. When a single-pot margin calculation is to be performed, the data on the member derivatives portfolio 101 and the member securities portfolio 102 may be obtained from their respective clearinghouses, and may be used to construct the member derivatives and securities portfolio 103. Margin calculations may then be performed on the member derivatives and securities portfolio 103, which may result in single-pot margin requirement.

In an alternative embodiment, the member derivatives and securities portfolio 103 may be persistent portfolio. For example, the member derivatives and securities portfolio 103 may serve as both the member derivatives portfolio 101 and the member securities portfolio 102, and may be accessed by both the derivatives and securities clearinghouses. The data for both securities and derivatives positions maintained by the member may be stored in the member derivatives and securities portfolio 103 at the same time, and may be maintained as a single portfolio instead of two separate portfolios.

The clearinghouse 104 may be a single clearinghouse, or multiple clearinghouses working in partnership, at which the clearing member may clear trades in their member derivatives portfolio 101 and member securities portfolio 102. The clearing member may be a member of the clearinghouse 104, which may calculate margin requirements and collect margin deposits from the clearing member. The margin calculation computer server 105 and clearing fund management system 106 may be operated by the clearinghouse 104. The clearinghouse 104 may maintain deposits made by clearing members to guarantee transactions cleared by the clearinghouse 104, including a or original margin. The clearinghouse 104 may be, for example, a partnership between New York Portfolio Clearing and the Fixed Income Clearing Corporation, coordinated by the Depository Trust & Clearing Corporation.

The margin calculation computer server 105 may be any suitable combination of hardware and software to allow for the receipt of data on derivatives and securities positions, and the calculation of a margin requirement based on the data. The margin calculation computer server 105 may be a computer system under the control of the clearinghouse 104, and may be able to send and receive data to and from other computer systems inside and outside of the clearinghouse 104. The margin calculation computer server 105 may calculate the margin requirements for clearing members using differing liquidations periods for derivatives positions and securities positions.

The margin requirements may be calculated according to a schedule set by the clearinghouse 104. For example, original margin may be calculated once per day, before the beginning of the trading day, and variation margin may be calculated twice per day, during the trading day. Original margin may also be calculated multiple times during the trading day, with a deficit collection process around one of the intraday original margin calculations. Once a margin requirement has been calculated, the margin requirement may be transmitted to the clearing fund management system 106 by the margin calculation computer server 105.

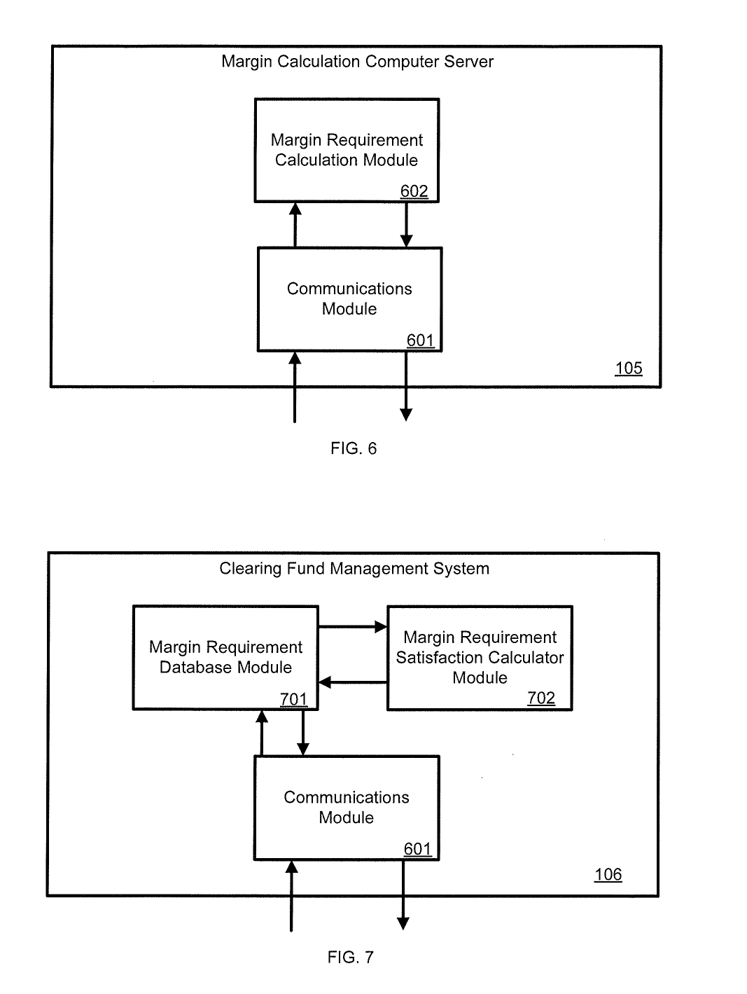

FIG. 6 depicts an exemplary margin calculation computer server for single-pot margining with differing liquidation periods. The margin calculation computer server 105 may be any suitable combination of hardware and software, and may include a margin requirement calculation module 602 and a communications module 601, which may be any suitable combination of hardware and software, and may use any suitable software written in any suitable language, as an executable or compilable software code.

The communications module 601 may allow the margin calculation computer server 105 to communicate electronically, for example, over the internet, with other computer systems. The communications module 601 may receive the securities and derivatives portfolio 103, for example, from the member computer system 107, and may transmit a margin requirement, for example, a single-pot margin requirement, to, for example, the member computer system 107.

The margin requirement calculation module 602 may be any suitable combination of hardware and software for calculating a margin requirement. The margin requirement calculation module 602 may use any suitable algorithm or methodology for calculating the margin requirement on the securities and derivatives portfolio 103, including, for example, using Value-at-Risk methodology with a differing liquidation periods for derivatives and securities, such as, for example, a one day liquidation period for derivatives and three day liquidation period for securities. Any suitable price simulation technique may be used by the margin requirement calculation module 602, including, for example, historical simulation or Monte Carlo simulation. The margin requirement may be passed to the communications module 601 after being calculated.

The clearing fund management system 106 may be any suitable combination of hardware and software for reporting margin requirements to clearing members and tracking margin deposits by clearing members. The clearing fund management system 106 may be a computer system under the control of the clearinghouse 104, and may be able to send and receive data to and from other computer systems inside and outside of the clearinghouse 104. The clearing fund management system 106 may receive calculated margin requirements from the margin calculation computer server 105, and make the calculated margin requirements available to the clearing members. For example, the clearing fund management system 106 may transmit a clearing member's margin requirement to the member computer system 107 of the clearing member using any suitable method, such as, for example, e-mail or proprietary messaging, or allow the member computer system 107 to access the margin requirement on the clearing fund management system 106. The clearing fund management system 106 may track the fulfillment of margin requirements by clearing members. The clearing fund management system 106 may also be accessed by clearing members to allow the clearing members calculate the effect of depositing a specific security to the clearing fund or original margin, and to initiate and submit requests to change the composition of the clearing member's original margin and clearing fund contribution.

In an alternative embodiment, the clearing fund management system 106 may be part of the same system as the margin calculation computer server 105. For example, the margin calculation computer server 105 and the clearing fund management system 106 may be implemented in one or more pieces of software running on the same hardware.

FIG. 7 depicts an exemplary clearing fund management system for single-pot margining with differing liquidation periods. The clearing fund management system 106 may be any suitable combination of hardware and software, and may include a margin requirements database module 701, a margin requirement satisfaction calculator module 702, and the communications module 601, which may be any suitable combination of hardware and software, and may use any suitable software written in any suitable language, as an executable or compilable software code.

The communications module 601 may allow the clearing fund management system 106 to communicate electronically, for example, over the internet, with other computer systems. The communications module 601 may receive margin requirements calculated by the margin calculation computer server 105, transmit margin requirements to the member computer system 107, and receive requests for margin requirements from the member computer system 107, transmit margin payment confirmations to the member computer system 107, receive margin payment confirmation requests from the member computer system 107, and receive asset transfer reports from the clearinghouse settling bank 109.

The margin requirements database module 701 may be any suitable combination of hardware and software for maintaining a database tracking the satisfaction of margin requirements by clearing members, including, for example, margin requirements calculated for clearing members and how much clearing members have paid towards satisfying margin requirements. For example, the margin requirements database module 701 may be an SQL database running on computer servers at the clearinghouse 104. The margin requirements database module 701 may be updated to reflect the calculation of margin requirements by the margin calculation computer server 105, and transfer of assets to the clearinghouse settling bank 109 by clearing members to satisfy margin requirements. When a clearing member, using, for example, the member computer system 107, requests to see the clearing member's margin requirement, the margin requirements database module 701 may pass the margin requirement to the communications module 601 to be sent to the member computer system 107.

The margin requirement satisfaction calculator module 702 may be any suitable combination of hardware and software to determine if a clearing member has satisfied the clearing member's margin requirement. For example, the margin requirement satisfaction calculator module 702 may check the margin requirements database module 701, and compare the margin requirement for a clearing member to the value of the assets the clearing member has transferred to the clearing fund or original margin in the clearinghouse settling bank 109. If the assets are valued at less than the margin requirement, the margin requirement satisfaction calculator module 702 may determine that the clearing member has not satisfied the margin requirement, and may use the communication modules 601 to transmit a message to the clearing member requesting additional assets. If the assets are valued equal to or greater than the margin requirement, the margin requirement satisfaction calculator module 702 may determine that the clearing member has satisfied the margin requirement.

The member computer system 107 may be any suitable combination of hardware and software to allow a clearing member to access the clearing fund management system 106 and the member settling bank 108. The clearing member may use the member computer system 107 to access the clearing fund management system 106 to check the clearing member's margin requirement, calculate the effect of depositing a specific security to the clearing fund or original margin, and to initiate and submit requests to change the composition of the clearing fund or original margin. The member computer system 107 may also receive data, such as the margin requirement, from the clearing fund management system 106. Once the clearing member is aware of the margin requirement, the member computer system 107 may be used to transmit instructions to the member settling bank 108 to transfer assets, such as a combination funds and securities, to the clearinghouse settling bank 109 to satisfy the margin requirement. The member computer system 107 may interface with, for example, the Fed Funds Settlement System, or the National Settlement Services, to allow for the transfer of assets to cover the margin requirement.

For example, the margin calculation computer server 105 may calculate a margin requirement for a clearing member of $1,000,000. The clearing member may use the member computer system 107 to access the margin requirement on the clearing fund management system 106. The clearing member may then use the member computer system 107 to instruct the member settling bank 108 to transfer $700,000 worth of funds and at least $300,000 worth of securities, depending on how securities are valued by the clearinghouse 104, to the clearinghouse settling bank 109.

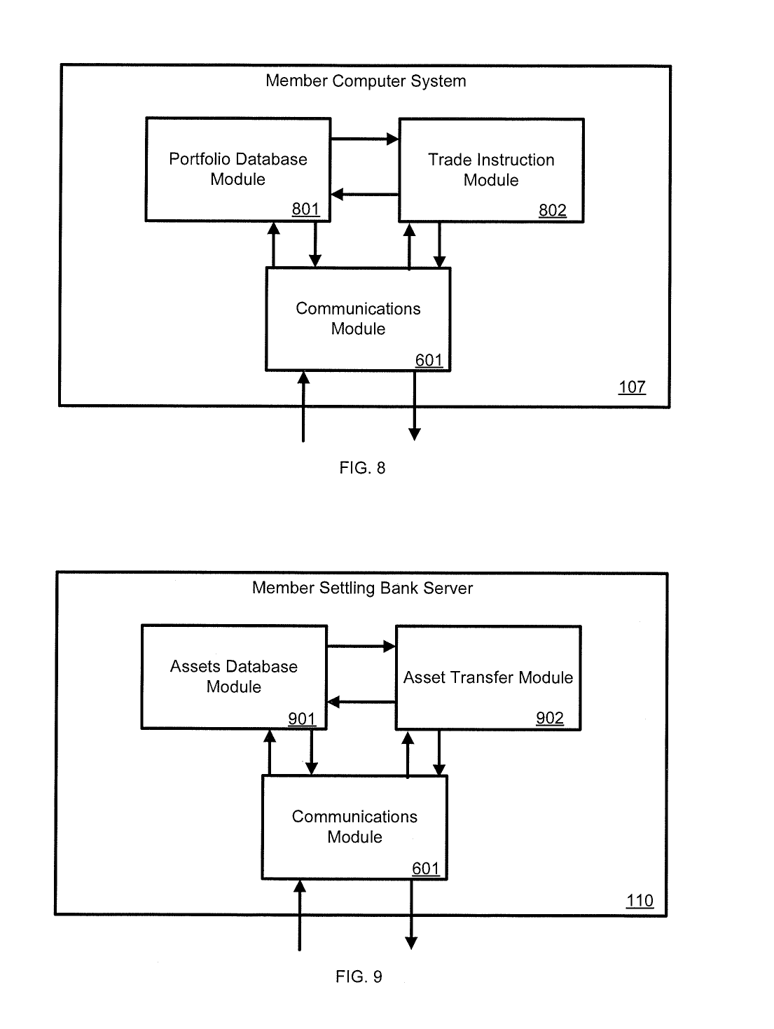

FIG. 8 depicts an exemplary member computer system for single-pot margining with differing liquidation periods. The member computer system 107 may be any suitable combination of hardware and software, and may include a portfolio database module 801, a trade instruction module 802, and the communications module 601, which may be any suitable combination of hardware and software, and may use any suitable software written in any suitable language, as an executable or compilable software code.

The communications module 601 may allow the member computer system 107 to communicate electronically, for example, over the internet, with other computer systems. The communications module 601 may receive margin requirements calculated by the margin calculation computer server 105, margin payment confirmations, requests for the member securities and derivatives portfolio 103, and confirmations of asset transfers, and transmit margin requirement requests, the member securities and derivatives portfolio 103, margin payment confirmation requests, and asset transfer instructions.

The portfolio database module 801 may be any suitable combination of hardware and software for maintaining a database of portfolios of derivatives and securities positions, for example, the member derivatives portfolio 101, the member securities portfolio 102, and the member derivatives and securities portfolio 103. For example, the portfolio database module 801 may be an SQL database. The portfolios in the portfolio database module 801 may include, for example, the portfolios of the clients of the clearing member. For example, the member derivatives portfolio 101 may include the clearing member's derivatives positions, and the derivatives positions maintained by the clients of the clearing member. When a single-pot margin requirement is calculated using the member derivatives portfolio 101, positions maintained by the clients of the clearing member may be excluded from the calculation, as the calculation may be performed only on the clearing member's proprietary positions. For the member derivatives portfolio 101, clearing members' proprietary positions may not be commingled with clients' or customers' positions, as customers may be subject to a completely separate margin calculation. For the member securities portfolio 102, proprietary and customer positions may be commingled at the clearinghouse level. The portfolio database module 801 may be updated to reflect changes to the portfolios, for example, from completed trades that have been cleared through the clearinghouse 104.

The trade instruction module 802 may be any suitable combination of hardware and software to generate instructions for trades, for example, on behalf of the clearing member for proprietary trading or from trade orders received from clients of the clearing member. The trade instruction module 802 may receive trade orders and generate instructions to be sent to, for example, an exchange, an OTC marketplace, or an inter-dealer broker, to implement the trade.

The member settling bank 108 may be the bank or other financial institution at which the clearing member keeps its assets. The member settling bank 108 may include a member settling bank server 110, which may be able to receive instructions from the clearing member for the transfer of assets or regarding the receipt of assets, such as, for example, electronic instructions sent from the member computer system 107. The member settling bank server 110 may be able to transfer assets, for example, electronically, from the member settling bank 108 to other financial institutions, such as, for example, the clearinghouse settling bank 109.

FIG. 9 depicts an exemplary member settling bank server for single-pot margining with differing liquidation periods. The member settling bank server 110 may be any suitable combination of hardware and software, and may include an assets database module 901, an asset transfer module 902, and the communications module 601, which may be any suitable combination of hardware and software, and may use any suitable software written in any suitable language, as an executable or compilable software code.

The communications module 601 may allow the member settling bank server 110 to communicate electronically, for example, over the internet, with other computer systems. The communications module 601 may receive asset transfer or receipt instructions, for example, from the member computer system 107, and may transmit the data necessary to affect an electronic transfer or receipt of assets from or to the member settling bank 108 from or to another financial institution.

The assets database module 901 may be any suitable combination of hardware and software for maintaining a database of assets held by the member settling bank 108, including, for example, the amount and type of assets and the owner of the assets. For example, the assets database module 901 may be an SQL database running on computer servers at the member settling bank 108. The assets database module 901 may be updated to reflect the addition or subtraction of assets, for example, when an asset owner instructs assets to be transferred out of the member settling bank 108.

The asset transfer module 902 may be any suitable combination of hardware and software to process the transfer of assets to and from the member settling bank 108. For example, when an asset transfer request is received by the communications module 601, the request may be passed to the asset transfer module 902, which may check the assets database module 901 to determine if the request is valid, i.e., the requester has enough assets to cover the transfer. The asset transfer module 902 may generate the instructions necessary to affect the asset transfer, and may pass these instructions to the communications module 601.

The clearinghouse settling bank 109 may be the bank or other financial institution where the clearinghouse 104 keeps the clearing fund, including the margin deposits from clearing members. The clearinghouse settling bank 109 may include a clearinghouse settling bank server 111, which may be able to receive asset transfers from other banks or financial institutions, such as, for example, electronic transfers from the member settling bank 108. The clearinghouse settling bank server 111 may also be able to communicate, for example, electronically, with the clearing fund management system 106. Upon receipt of a clearing member's assets from the member settling bank 108, the clearinghouse settling bank server 111 may transmit data about the assets received to the clearing fund management system 106. The clearing fund management system 106 may use the data on the transferred assets to determine if the clearing member has satisfied the margin requirement. The clearinghouse settling bank server 111 may also have access to the margin requirements from the clearing fund management system 106, and may determine if asset transfers satisfy the margin requirement for a clearing member.

For example, after receiving the $700,000 in funds and securities valued by the clearinghouse 104 at $300,000 from the member settling bank 108 at the clearinghouse settling bank, the clearinghouse settling bank server 111 may transmit to the clearing fund management system 106 that the clearing member has transferred $1,000,000 of total assets to the clearing fund. The clearing fund management system 106 may then determine that the clearing member has satisfied the margin requirement.

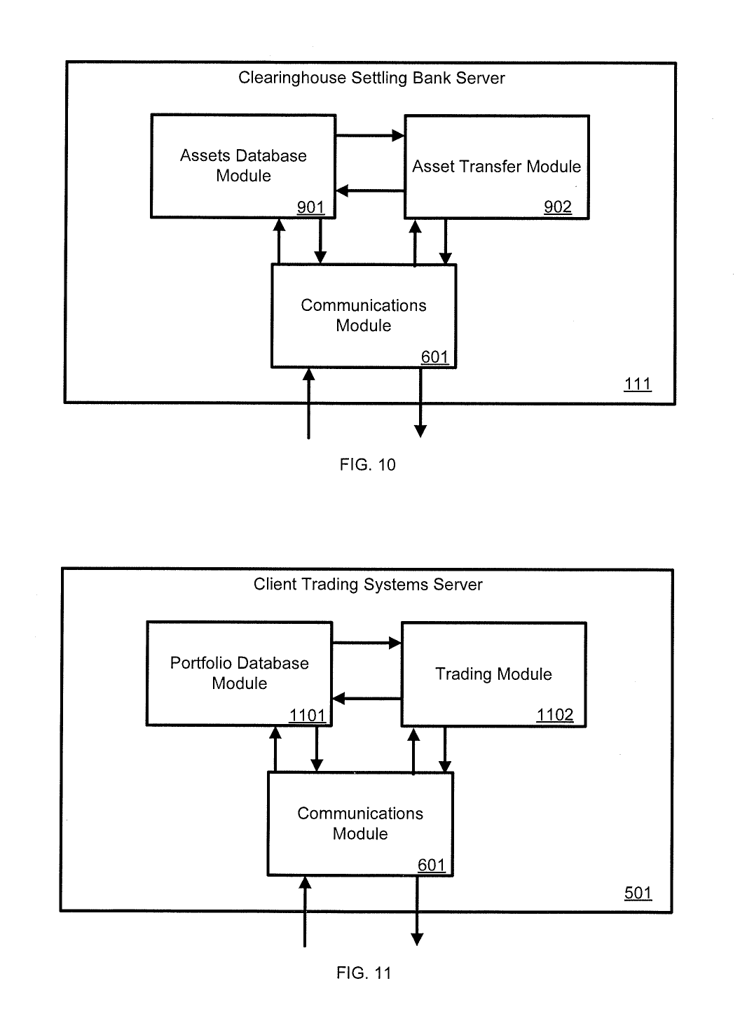

FIG. 10 depicts an exemplary clearinghouse settling bank server for single-pot margining with differing liquidation periods. The clearinghouse settling bank server may be any suitable combination of hardware and software, and may include the assets database module 901, the asset transfer module 902, and the communications module 601, which may be any suitable combination of hardware and software, and may use any suitable software written in any suitable language, as an executable or compilable software code.

The communications module 601 may be allow the clearinghouse settling bank server 111 to communicate electronically, for example, over the internet, with other computer systems. The communications module 601 may receive asset transfer data, for example, from the member settling bank server 110, and may transmit a report of the asset transfer to the clearing fund management system 106.

The assets database module 901 may be any suitable combination of hardware and software for maintaining a database of assets held by the clearinghouse settling bank 109, including, for example, the amount and type of assets and the owner of the assets. For example, the assets database module 901 may be an SQL database running on computer servers at the clearinghouse settling bank 109. The assets database module 901 may be updated to reflect the addition or subtraction of assets, for example, when assets are transferred from the member settling bank 108 to the clearing fund of the clearinghouse 104 held at the clearinghouse settling bank 109.

The asset transfer module 902 may be any suitable combination of hardware and software to process the transfer of assets to and from the clearinghouse settling bank 109. For example, when asset transfer data is received by the communications module 601, the request may be passed to the asset transfer module 902, which may update the assets database module 901 with the assets that have been transferred to the clearinghouse settling bank 109. The asset transfer module 902 may process the data necessary to affect the asset transfer.

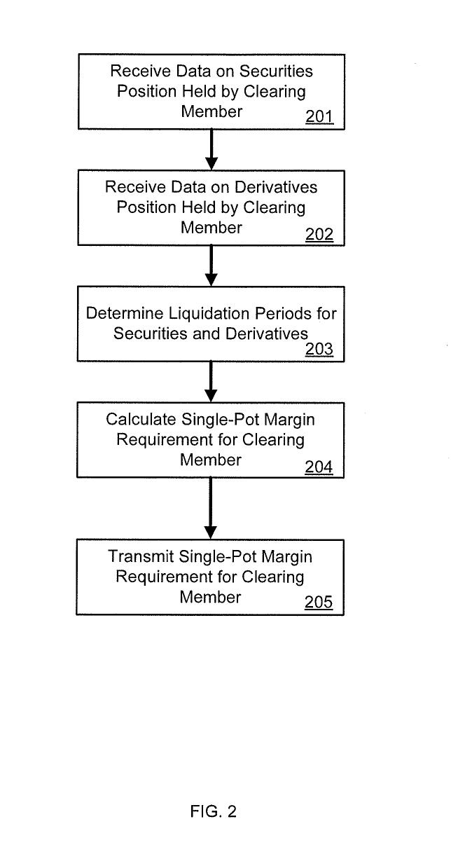

FIG. 2 depicts an exemplary procedure for single-pot margining with differing liquidation periods. In block 201, data on securities positions maintained by a clearing member may be received. For example, the margin calculation computer server 105 may receive data on the securities positions in the member securities portfolio 102. The data may be received from, for example, the clearing member maintaining the member securities portfolio 102, from a computer system controlled by the clearinghouse 104 that keeps data on the portfolios of clearing members, or from a computer system controlled by the securities clearinghouse at which the member securities portfolio 102 is maintained. The data may also be part of the member derivatives and securities portfolio 103.

In block 202, data on derivatives positions maintained by the clearing member may be received. For example, the margin calculation computer server 105 may receive data on the derivatives positions in the member derivatives portfolio 101. The data may be received from, for example, the clearing member maintaining the member derivatives portfolio 101, from a computer system controlled by the clearinghouse 104 that keeps data on the portfolios of clearing members, or from a computer system controlled by the securities clearinghouse at which the member derivatives portfolio 101 is maintained. The data may also be part of the member derivatives and securities portfolio 103.

In block 203, the liquidation periods for the securities and derivatives may be determined. The single-pot margin calculation may use differing liquidation periods for derivatives and securities. The liquidation periods may determined in any suitable manner. For example, the liquidation period for securities may be determined based on empirical observation and/or statistical analysis of the amount of time securities take to liquidate. As another example, the liquidation period for securities may be set at a certain number of days without regard to observed data. In another embodiment, differing liquidation periods may be determined for individual securities and derivatives, such that two securities in the same member securities portfolio 102 may have differing liquidation periods for the purposes of the single-pot margin calculation.

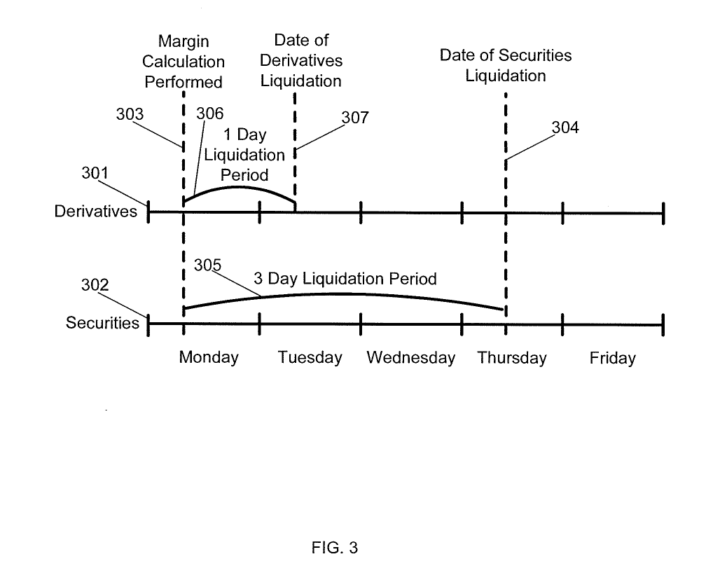

FIG. 3 depicts an exemplary timeline for single-pot margining with differing liquidation periods. A derivatives timeline 301 may represent how derivatives positions are treated during the single-pot margin calculation. A securities timeline 302 may represent how securities positions are treated during the single-pot margin calculation. At time point 303, on Monday, the margin calculation may be performed, for example, by the margin calculation computer server 105. The margin calculation may assume the clearing member has defaulted at the time the margin calculation is performed. The margin calculation computer server 105 may use a three day liquidation period 305 for the securities position, resulting in a liquidation date on the securities timeline 302 of Thursday, at time point 304. The time point 304 may be the date on which the securities could be liquidated by if the clearing member defaulted at the time point 303. A one day liquidation period 306 for derivatives positions, if started at the time point 303 on the derivatives timeline 301, may end on Tuesday, at the time point 307, two days before the time point 304. The time point 307 may be the date on which the derivatives could be liquidated by if the clearing member defaulted at the time point 303.

In block 204, a single-pot margin requirement may be calculated for the clearing member based on the data on the derivatives positions and the securities positions received in blocks 202 and 203. The margin calculation computer server 105 may use the data on the positions in the clearing member's member derivatives portfolio 101 and member securities portfolio 102, which may be combined as the member derivatives and securities portfolio 103, along with the price simulations performed in block 203 for the derivatives positions, to calculate the margin requirement for the clearing member. The single-pot margin requirement may cover the clearing member's member derivatives portfolio 101 and member securities portfolio 102.

The margin calculation computer server 105 may use any suitable margin calculation methodology, and may use differing liquidation periods for the derivatives positions and securities positions. For example, the margin calculation computer server 105 may use Value-at-Risk methodology with a 99% confidence level and a “3+1” liquidation period. The “3+1” liquidation period may be a three day liquidation period for securities positions and a one day liquidation period for derivatives positions. The liquidation periods used by the margin calculation computer server 105 may be the liquidation periods determined in block 203. The margin calculation computer server 105 may use mark-to-market accounting for the valuation of derivatives positions and securities positions as part of the margin requirement calculation, and may use any suitable price simulation techniques, such as, for example, an historical price simulation or Monte Carlo price simulation.

The margin calculation computer server 105 may also create risk parameter files, such as, for example, London SPAN risk parameter files, in conjunction with performing the margin requirement calculation.

In block 205, the single-pot margin requirement for the clearing member may be transmitted. For example, the margin calculation computer server 105 may transmit the single-pot margin requirement to the clearing fund management system 106, where the clearing member may access the single-pot margin requirement. Or, as another example, the margin calculation computer server 105 may transmit the single-pot margin requirement directly to the clearing member.

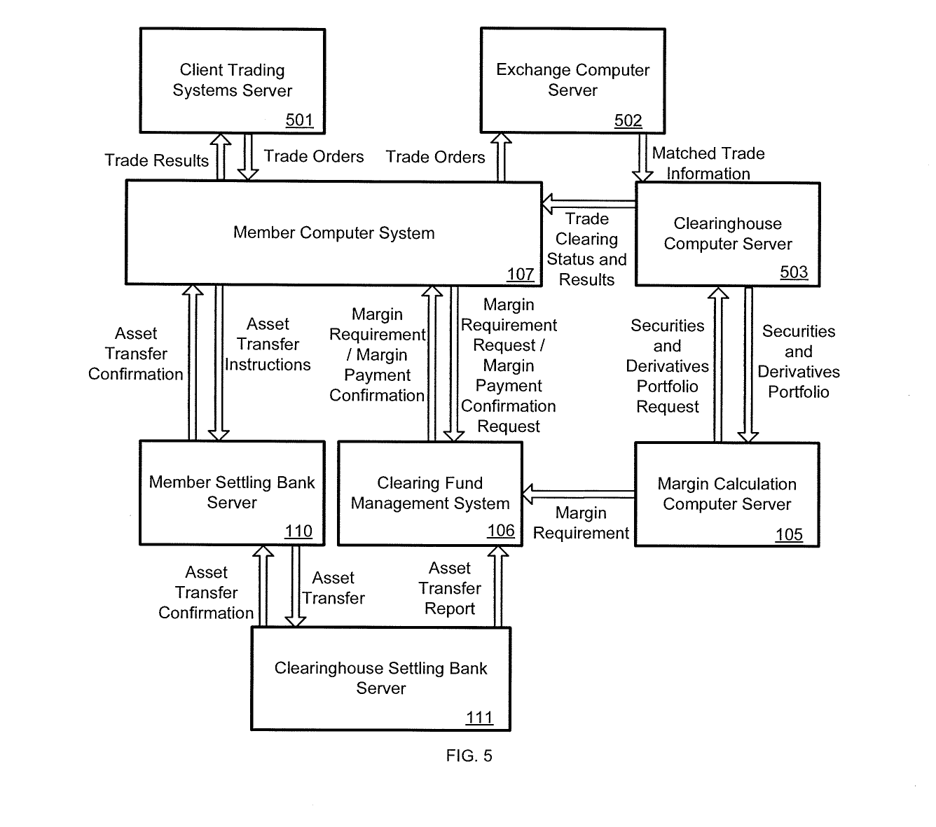

FIG. 5 depicts an exemplary system architecture for single-pot margining with differing liquidation periods. The system may include a client trading server 501, an exchange computer server 502, a clearinghouse computer server 503, the member computer system 107, the margin calculation computer server 105, the clearing fund management system 106, the clearing member settling bank server 110, and the clearinghouse settling bank server 111.

FIG. 11 depicts an exemplary client trading systems server for single-pot margining with differing liquidation periods. The client trading systems server 501 may be any suitable combination of hardware and software, and may include a portfolio database module 1101, a trading module 1102, and the communications module 601, which may be any suitable combination of hardware and software, and may use any suitable software written in any suitable language, as an executable or compilable software code. The client trading systems server 501 may be used by clients of the member of the clearinghouse 104 to trade on the exchange the clearinghouse 104 clears trades for, or may be used by members of the exchange to trade on the exchange. The client trading systems server 501 may also be used to trade in OTC marketplaces, through inter-dealer brokers, and via firm-to-firm trading. Portfolios transacted by a client of clearing member using the client trading systems server 501 may be excluded from single-pot margin calculations performed on the clearing member's portfolios.

The communications module 601 may allow client trading systems server 501 to communicate electronically, for example, over the interne, with other computer systems. The communications module 601 may transmit trading instructions, for example to the member computer system 107, including trades the client wishes to make, and may receive the status of the trades from the exchange computer server 502 or the clearinghouse computer server 503.

The portfolio database module 1101 may be any suitable combination of hardware and software for maintaining a database of positions, such as, for example, securities positions and derivatives positions, maintained by the client in a portfolio using the client trading systems server 501. For example, the assets database module 901 may be an SQL database running on computer servers. The portfolio database module 1101 may be updated to reflect changes in the positions resulting from completed trades, for example, when a security is sold.

The trading module 1102 may be any suitable combination of hardware and software to generate trade instructions to be sent to the member computer system 107, and process the results of trades made based on the instructions. For example, a trader working for the client and using the client trading systems server 501 may use the trading module 1102 to generate instructions for the purchase or sale of derivatives or securities on behalf of the client. The trading module 1102 may send the instructions through the communications module 601. The trading module 1102 may process the results of the trade, for example, updating the database in portfolio database module 1101 to reflect the sale of the securities if the trade succeeded, or sending a notification to the trader if the trade failed.

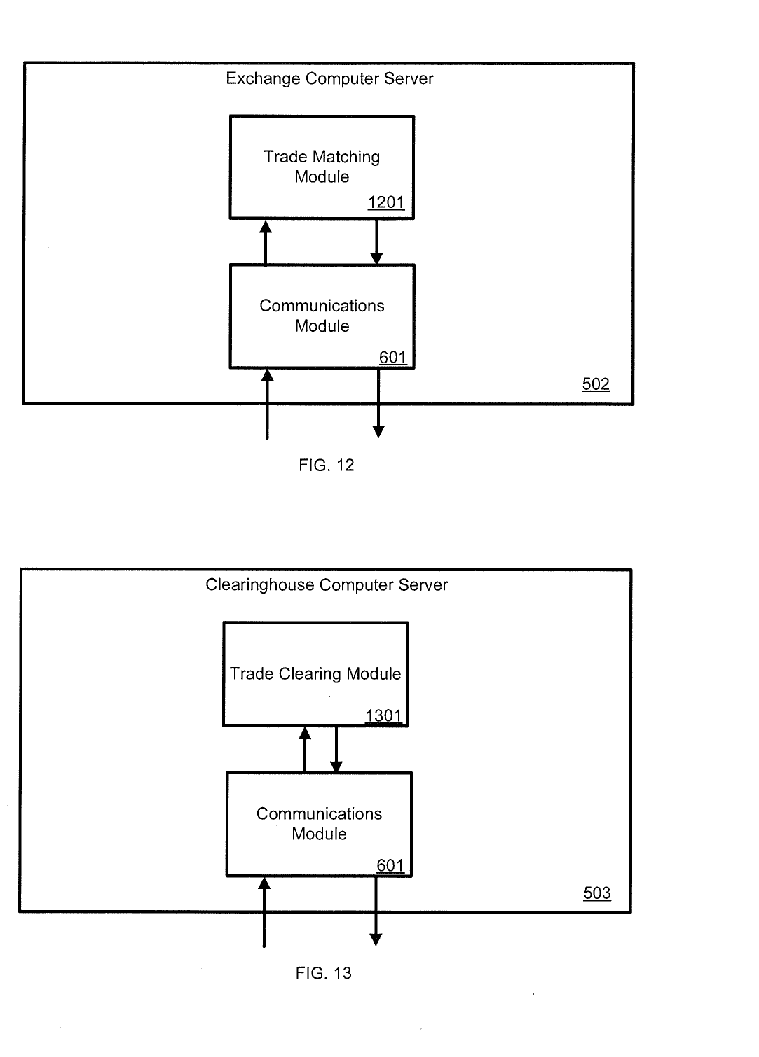

FIG. 12 depicts an exemplary exchange computer server for single-pot margining with differing liquidation periods. The exchange computer server 502 may be any suitable combination of hardware and software, and may include a trade matching module 1201, a market price module 1202, and the communications module 601, which may be any suitable combination of hardware and software, and may use any suitable software written in any suitable language, as an executable or compilable software code. The exchange computer server 502 may process trades and track prices on an exchange, for example, for securities or derivatives.

The communications module 601 may allow the exchange computer server 502 to communicate electronically, for example, over the internet, with other computer systems. The communications module 601 may receive trade orders for, example, from the member computer system 107, transmit matched trades to the clearinghouse computer server 503, receive the results of trader orders sent to the exchange computer server 502, and transmit the results of trades to the member computer system 107 and the client trading systems server 501.

The trade matching module 1201 may be any suitable combination of hardware and software for matching trade orders. The exchange computer server 502 may receive trade orders from various clearing members, on the behalf of both the clearing members and the clients of the clearing members. The requests may be for the purchase or sale of securities or derivatives. The trade matching module 1201 may examine the received requests and attempt to match the requests to form matched trades, for example, matching a request to sell derivative A by one party with a request to buy derivative A by another party. The matched trades generated by the trade matching module 1201 may be sent to the clearinghouse computer server 503.

FIG. 13 depicts an exemplary clearinghouse computer server for single-pot margining with differing liquidation periods. The clearinghouse computer server 503 may be any suitable combination of hardware and software, and may include a trade clearing module 1301 and the communications module 601, which may be any suitable combination of hardware and software, and may use any suitable software written in any suitable language, as an executable or compilable software code. The clearinghouse computer server 503 may be part of the clearinghouse 104, and may clear matched trades received, for example, from the exchange computer server 502. If the clearinghouse 104 is a partnership between multiple clearinghouses, for example, a derivatives clearinghouse and a securities clearinghouse, each clearinghouse may have its own clearinghouse computer server 503, and trades may be routed to the appropriate clearinghouse computer server 503.

The communications module 601 may allow the clearinghouse computer server 503 to communicate electronically, for example, over the interne, with other computer systems. The communications module 601 may receive matched trades for, example, from the exchange computer server 502, and transmit the status of matched trades after attempting to clear them to the exchange computer server 502.

The trade clearing module 1201 may be any suitable combination of hardware and software for clearing matched trades. The clearinghouse computer server 503 may receive matched trades from the exchange computer server 502 through the communications module 601. The matched trades may include a security or derivative being traded, a buyer, and a seller. The trade clearing module 1201 may perform any functions needed to clear a trade, and may report if a trade cannot clear.

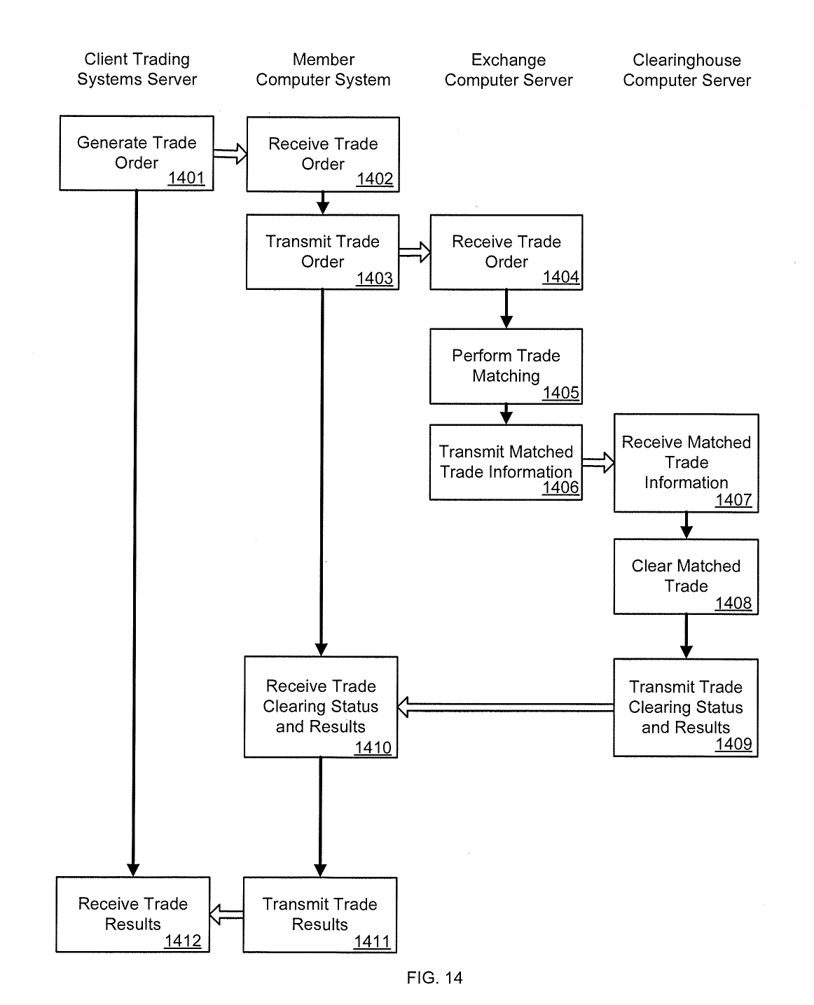

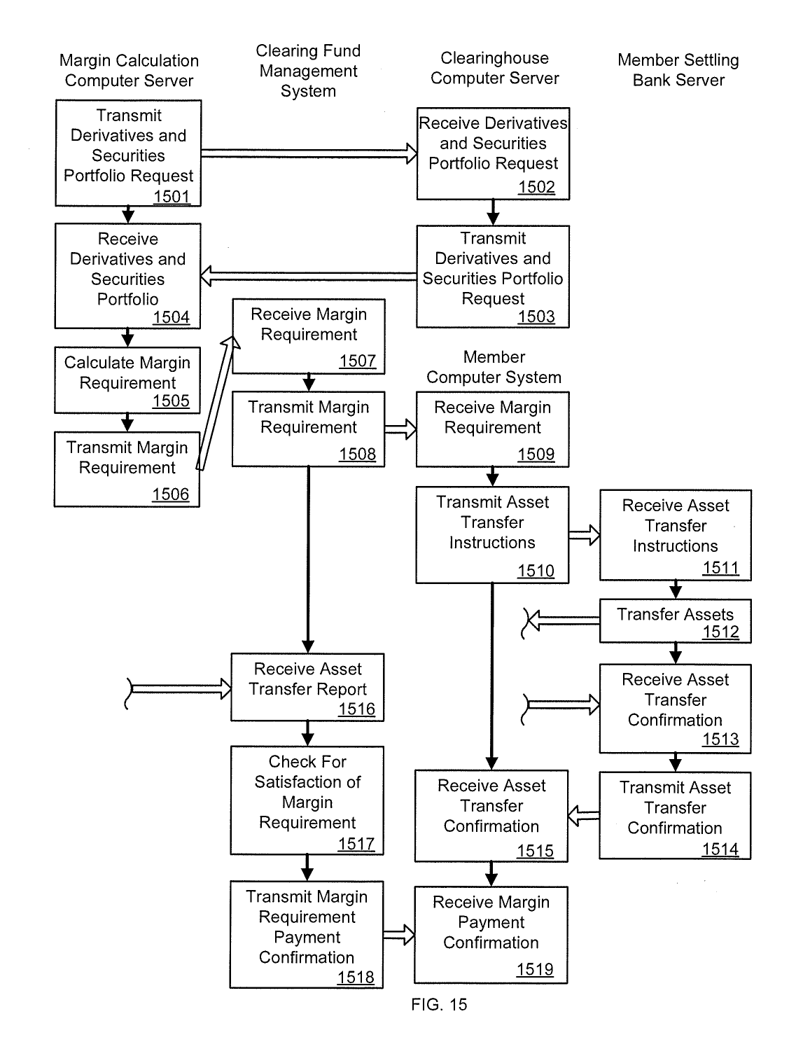

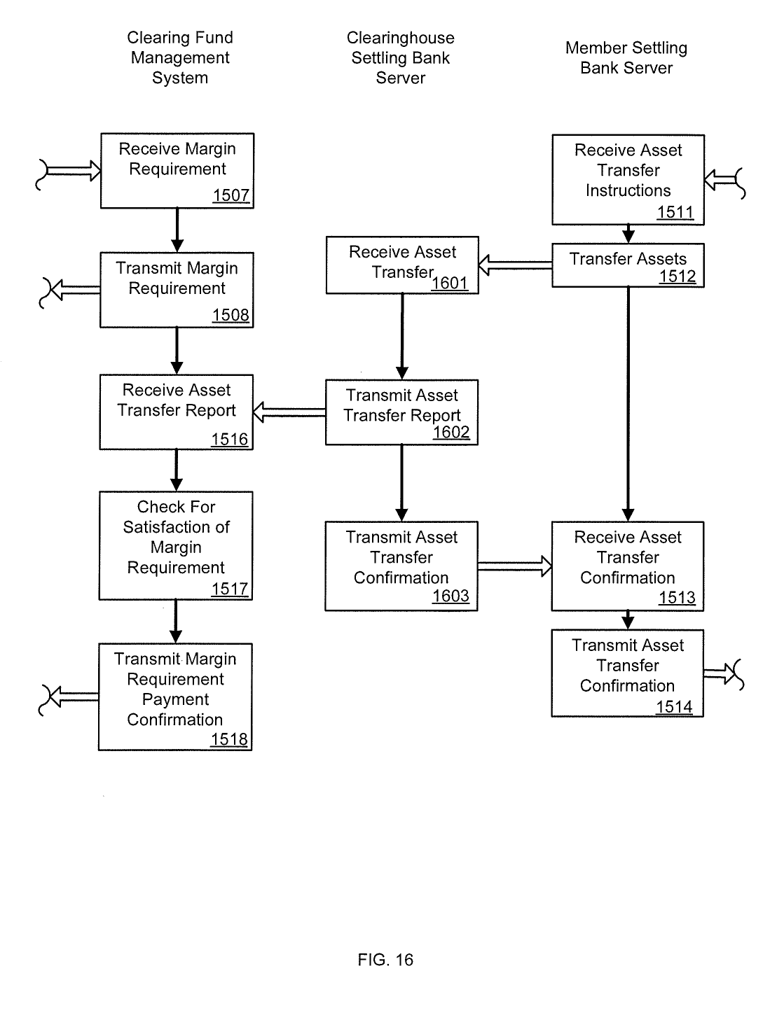

FIGS. 14, 15 and 16 depict exemplary inter-system flow charts for single-pot margining with differing liquidation periods. In block 1401, the client trading systems server 501 may send a trade order to the exchange computer server 502. The member computer system 107 may also generate trade orders for the clearing member's proprietary trading, and transmit those trade orders to the exchange computer server 502. If the trade is for securities, the trade may not go to an exchange computer server 502, and may instead go to, for example, an inter-broker dealer, or directly to the other party to the trade. In block 1402, the exchange computer server may receive the trade order, and in block 1403 may attempt to match the trade. If the trade is matched, the matched trade information may be transmitted to the clearinghouse computer server 503 and to the client trading systems server 501. In block 1405, the client trading systems sever 501 may receive the matched trade information, and, for example, notify the trader who originated the trade order. In block 1406 the clearinghouse computer server 503 may receive the matched trade information and in block 1408 may clear the trade. In block 1409 the clearinghouse computer server 503 may transmit trade clearing status and cleared trade results back to the member computer system 107, indicating that the trade has cleared. In block 1409 the member computer system 107 may receive the trade clearing status and cleared trade results. If the trade order originated with the client trading systems server 501, in block 1410 the member computer system 107 may transmit the results of the trade, for example, that the trade clearing status and cleared trade results, back the client trading systems server 501. The client trading systems server 501 may receive the trade clearing status and cleared trade results in block 1411.

In block 1501, the margin calculation computer server 105 may request data on the member derivatives and securities portfolio 103 from the clearinghouse computer server 503. For example, the clearinghouse 104 may indicate to the margin calculation computer server 105 that a single-pot margin calculation is needed, resulting in the margin calculation computer server 105 requested the necessary data. In block 1502, the clearinghouse computer server 503 may receive the request, and in block 1503 may transmit the data on the member derivatives and securities portfolio 103 to the margin calculation computer server 105. If the data on the member derivatives portfolio 101 and the member securities portfolio 102 are stored at separate clearinghouses, the margin calculation computer server 105 may request the data from the clearinghouse computer server 503 for each of the separate clearinghouses. In block 1504, the margin calculation computer server 105 may receive the data on the member derivatives and securities portfolio 103, and in block 1505 may use the data on the member derivatives and securities portfolio 103 to calculate a margin requirement, for example, a single-pot margin requirement. The calculation of the single-pot margin requirement may use only a clearing member's proprietary positions, and exclude positions maintained by clients of the clearing member. In block 1506, the margin calculation computer server 105 may transmit the margin requirement to the clearing fund management system 106.

In block 1507, the clearing fund management system 106 may receive the margin requirement, and in block 1508 may transmit the margin requirement to the member computer system 107, either automatically or on request from the member computer system 107. In block 1509, the member computer system 107 may receive the margin requirement, and in block 1510 may transmit asset transfer instructions to the member settling bank server 110. In block 1511, the member settling bank server 110 may receive the asset transfer instructions, and in block 1512 may implement the asset transfer instructions, and perform an asset transfer to the clearinghouse settling bank server 111. In block 1601, the clearinghouse settling bank server 111 may receive the asset transfer, and in block 1602 may transmit a report of the asset transfer to the clearing fund management system 106. In block 1603, the clearinghouse settling bank server 111 may transmit a confirmation of the asset transfer back to the member settling bank server 110. In block 1513, the member settling bank server 110 may receive the asset transfer confirmation, and in block 1514 may transmit the asset transfer confirmation back to the member computer system 107. In block 1515, the member computer system 107 may receive the asset transfer confirmation. In block 1516, the clearing fund management system 106 may receive the asset transfer report, and in block 1517 may determine if the asset transfer has satisfied the margin requirement. In block 1518, the clearing fund management system 106 may transmit a confirmation of payment on the margin requirement to the member computer system 107, either automatically or on request from the member computer system 107. In block 1519, the member computer system 107 may receive the margin payment confirmation.

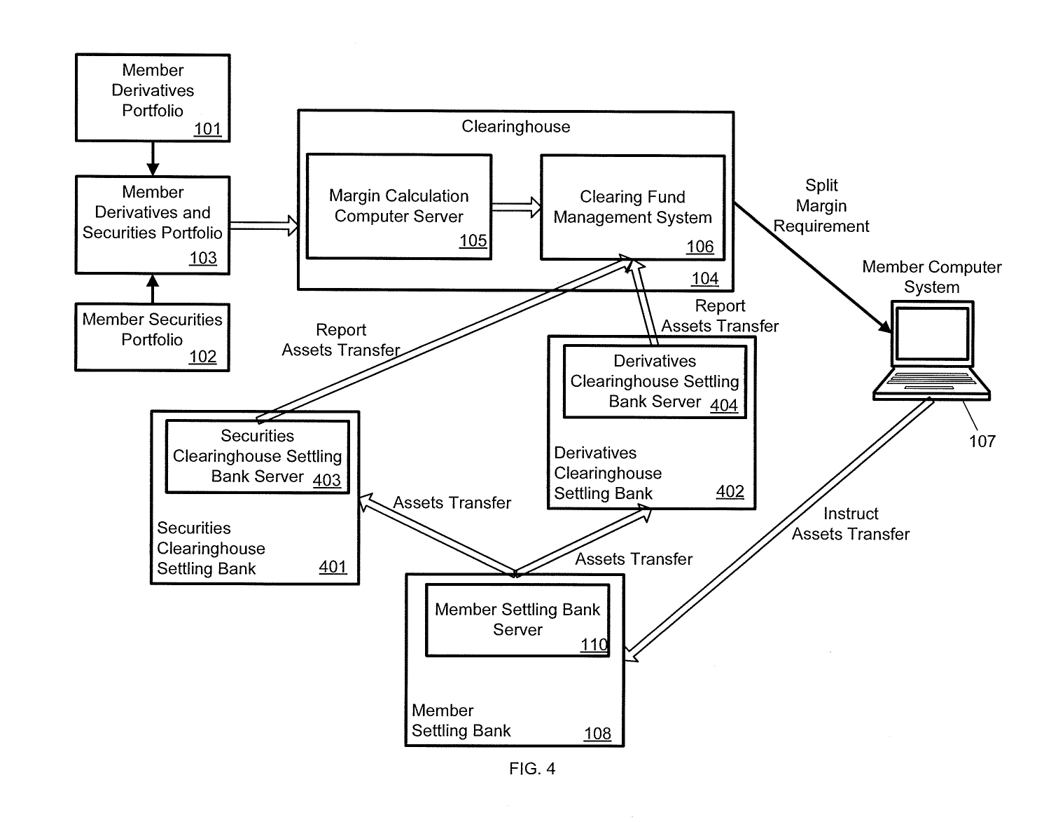

FIG. 4 depicts an exemplary system for single-pot margining with differing liquidation periods and margin deposits split between settling banks. In FIG. 1, the assets used by the clearing member to satisfy the margin requirement calculated by the margin calculation computer server 105 may be held by the clearinghouse settling bank 109. If the margin requirement is a single-pot margin requirement, as in FIG. 2, the portfolio on which the margin requirement was calculated may include both derivatives positions and securities positions, such as in the member derivatives and securities portfolio 103. The member derivatives and securities portfolio 103 may be a combination of two separate portfolios, the member derivatives portfolio 101 and the member securities portfolio 102, which may be cleared through separate clearinghouses, a derivatives clearinghouse and securities clearinghouse. The separate clearinghouses may be working in partnership as the clearinghouse 104.

The derivatives clearinghouse and the securities clearinghouse may not wish to share the same account, or the same bank, for holding margin deposits. The securities clearinghouse may wish to hold margin deposits in the securities clearinghouse settling bank 401, and the derivatives clearinghouse may wish to hold margin deposits in the derivatives clearinghouse settling bank 402. However, the margin calculation computer server 105 may be calculating a single-pot margin requirement, which covers both securities and derivatives positions. The margin calculation computer server 105 may need to split the single-pot margin requirement into separate components, so that the clearing member may instruct the clearing member settling bank 108 to make separate asset transfers to the securities clearinghouse settling bank 401, through the securities clearinghouse bank server 403, and the derivatives clearinghouse settling bank 402, through the derivatives clearinghouse bank server 404. Or, the clearing member may instruct the clearing member settling bank 108 to make one transfer, to either the derivatives clearinghouse settling bank 402 or the securities clearinghouse settling bank 401, with the receiving settling bank transferring the proper portion of the assets to the other settling bank. The securities clearinghouse bank server 403 and the derivatives clearinghouse settling bank server 404 may operate similarly to the clearinghouse settling bank server 111.

The margin calculation computer server 105 may split the single-pot margin requirement by calculating separate margin requirements for the member derivatives portfolio 101 and the member securities portfolio 102. The sum of the separate margin requirements may be higher than the single-pot margin requirement. The margin calculation computer server 105 may then use any suitable technique to split the single-pot margin requirement, for example, applying the percentage each of the separately calculated margin requirements contributes to the sum to the single-pot margin requirement, splitting the single-pot margin requirement. For example, if the single-pot margin requirement is calculated as $1,000,000, the separate margin requirement for the member derivatives portfolio 101 is calculated at $1,200,000, and the separate margin requirement and the member securities portfolio 102 is calculated at $800,000, the sum of the separate requirements is $2,000,000, of which the member derivatives portfolio 101 accounts for 60% and the member securities portfolio 102 accounts for 40%. Applying the percentages to the single-pot margin requirement, the securities clearinghouse settling bank 401 may receive 40% of $1,000,000, or $400,000, and the derivatives clearinghouse settling bank 402 may received 60% of $1,000,000, or $600,000.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media. Examples of communication media that can be employed include, without limitation, wireless data networks, wireline networks, and/or a variety of networked media.

Computers and computer systems described herein may include operatively associated non-transitory computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like tangible, non-transitory computer-readable media.

In general, computer-readable media may include any medium capable of being a carrier for an electronic signal representative of data stored, communicated or processed in accordance with embodiments of the present invention. Where applicable, method steps described herein may be embodied or executed as instructions stored on a tangible, non-transitory computer-readable medium or media. The software is executable on a processor of the computers or computer systems to perform algorithms as described so that the computers function as particular machines for performing the method steps

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

We claim:

1. A computer-implemented method of determining a margin for a clearinghouse customer position including both securities and derivatives, comprising the steps of:
receiving data at a margin calculation computer server on at least one securities position held by a clearing member, the data on the at least one securities position being received by the margin calculation computer server via at least one communication channel;
receiving data at a margin calculation computer server on at least one derivatives position held by the clearing member, the data on the at least one derivatives position being received by the margin calculation computer server via at least one communication channel; and
calculating using the margin calculation computer server a single margin requirement for the clearing member for both the at least one securities position and the at least one derivatives position using a first liquidation period for the at least one securities position and a second different liquidation period for the at least one derivatives position in the calculation of the margin requirement, the calculating step being performed by a processor of the margin calculation computer server programmed to perform the calculation by executing software stored on a non-transitory computer readable media.

2. The method of claim 1, further comprising the step of:
calculating a risk of failure to settle/clear for the customer, the risk of failure calculating step being performed by the margin calculation computer server.

3. The method of claim 2, wherein the step of calculating the risk of failure uses Value-at-Risk methodology.

4. The method of claim 2, further comprising the step of:
determining the margin requirement based on the risk of failure to settle/clear for the clearing member.

5. The method of claim 3, wherein the Value-at-Risk methodology uses a 99% confidence level.

6. The method of claim 1, wherein the margin calculation uses a 3-day liquidation period for at least one securities position and a 1-day liquidation period for the at least one derivatives position.

7. The method of claim 1, wherein the step of calculating using the margin calculator computer server a single margin requirement further uses mark-to-market accounting.

8. The method of claim 1, wherein the step of calculating using the margin calculator computer server a single margin requirement further uses a coverage component.

9. The method of claim 1, wherein the margin calculated in the calculating step is an initial margin.

10. The method of claim 1, wherein the margin calculated in the calculating step is a variation margin.

11. The method of claim 3, wherein the Value-at-Risk methodology is historic simulation Value-at-Risk.

12. The method of claim 1, wherein the at least one derivatives position is a derivative cleared by New York Portfolio Clearing.

13. The method of claim 1, wherein the at least one securities positions is a fixed income security.

14. The method of claim 1, wherein the at least one securities positions is in a Fixed Income Clearing Corporation portfolio.

15. The method of claim 1, wherein the at least one securities positions is at least one of bonds, stocks, asset-backed securities, exchange traded funds, and credit-linked notes.

16. The method of claim 1, wherein the at least one derivatives position is at least one of options, futures, warrants, forwards and swaps.

17. The method of claim 2, wherein the risk type is at least one of settlement risk, systemic risk, non-systemic risk, default risk, pre-settlement risk, liquidity risk, and replacement risk.

18. The method of claim 1, wherein the margin calculation step uses a Monte Carlo simulation.

19. The method of claim 1, wherein the margin calculation step uses historical simulation.

20. The method of claim 1, further comprising the step of:
dividing using the margin calculation computer server the single margin requirement among two banks according to stand-alone margin ratios.

21. A computer-implemented method of determining a margin for a clearinghouse customer position including both securities and derivatives, comprising the steps of:
sending data to a margin calculation computer server on at least one securities position held by a clearing member, the data on the at least one securities position being sent via a communication channel;
sending data to a margin calculation computer server on at least one derivatives position held by the clearing member, the data on the at least one derivatives position being sent via a communication channel; and
receiving from the margin calculation computer server a single margin requirement for the clearing member for both the at least one securities positions and the at least one derivatives positions using a first liquidation period for the at least one securities position and a second different liquidation period for the at least one derivatives position in the calculation of the margin requirement, the margin requirement being calculated by the margin calculation computer server using a processor programmed to perform the calculation by executing software stored on a non-transitory computer readable media.
